(19) United States
(12) Patent Application Publication
(10) Pub. No.: US 2015/0012394 A1
(43) Pub. Date: Jan. 8, 2015

(54) Virtual Shopping System

(71) Applicant: Avenue Imperial UK Limited, London (GB)

(72) Inventors: Nicolas Rossi, London (GB); Julian Ball, London (GB); Thomas Mills, Essex (GB)

(73) Assignee: Avenue Imperial UK Limited, London (GB)

(21) Appl. No.: 14/294,582

(22) Filed: Jun. 3, 2014

Related U.S. Application Data
(60) Provisional application No. 61/842,080, filed on Jul. 2, 2013.
(60) Provisional application No. 61/944,828, filed on Feb. 26, 2014.

(51) Int. Cl. G06Q 30/06

(52) U.S. Cl. CPC G06Q 30/0643
USPC 705/27.2

(57) ABSTRACT

A system and method of virtual shopping is provided. The system and method includes a plurality of data services. The system and method includes a content delivery network receives at least one request from at least one of a plurality of data services. The system and method includes at least two devices operate in a communication protocol that receive data from the content delivery network, each of the at least two devices include a virtual reality interface. The virtual reality interface creates a user a virtual replica of a physical store. The virtual reality interface locates one or more objects of interest from the virtual reality interface. The virtual reality interface interacts with at least two devices located in the physical store through a virtual snapshot by the virtual reality interface of a user's current view of the virtual replica to facilitate purchase of one or more objects of interest.

### PRIORITY INFORMATION

This application claims priority from provisional applications Ser. No. 61/842,080 filed Jul. 2, 2013, and Ser. No. 61/944,828 filed Feb. 26, 2014, each of which is incorporated herein by reference in its entirety.

### BACKGROUND OF THE INVENTION

This invention is related to the field of virtual shopping systems, and in particular to virtual reality interfaces.

Recently, virtual shopping has become more popular with the development of technology to provide for convenience and simplicity without having to physically enter a store. This provides for a win-win situation for the customer, in terms of comfort, as well as the shop owner, in terms of business, customer satisfaction, and even marketing. As a consequence, the customer may shop at their own ease.

### SUMMARY OF THE INVENTION

According to one aspect of the invention, there is provided a virtual shopping system. The system includes a plurality of data services. The system includes a content delivery network that receive at least one request from at least one of the data services. The system includes at least two devices operating in a communication protocol that receives data from the content delivery network, the at least two devices each include a virtual reality interface. Each virtual reality interface creates a user a virtual replica of a physical store, locates one or more objects of interest from the virtual reality interface; and interacts with the at least two devices located in the physical store through a virtual snapshot by the virtual reality interface of a user's current view of the virtual replica to facilitate purchase of one or more objects of interest.

According to another aspect of the invention, there is provided a method of virtual shopping. The method includes the step of providing a plurality of data services. The method includes the step of providing a content delivery network that receive at least one request from at least one of the data services. The method includes the step of providing at least two devices operating in a communication protocol that receives data from the content delivery network, the at least two devices each include a virtual reality interface. The virtual reality interface creates a user a virtual replica of a physical store, locates one or more objects of interest from the virtual reality interface, and interacts with the at least two devices located in the physical store through a virtual snapshot by the virtual reality interface of a user's current view of the virtual replica to facilitate purchase of one or more objects of interest.

### BRIEF DESCRIPTION OF THE DRAWINGS

FIG. 1 is a schematic diagram illustrating a sample view of names and locations of numerous shopping venues of the virtual reality interface.

FIG. 2 is a schematic diagram illustrating a sample view of the virtual reality interface.

FIG. 3 is a schematic diagram illustrating a sample view of a customer chat window of the virtual shopping system.

FIG. 4 is a schematic diagram illustrating a sample view of an assistant chat window of the virtual shopping system.

FIGS. 5A, 5B, and 5C depict a flow chart illustrating the steps of execution of a virtual snapshot of the virtual shopping system involving a customer and assistant.

FIG. 6 is a block diagram of the virtual shopping system architecture.

FIG. 7 is a flow chart illustrating the steps of the product code interaction with the virtual reality interface.

FIG. 8 is a schematic diagram illustrating product codes of the virtual reality interface.

### DETAILED DESCRIPTION OF THE INVENTION

The invention provides a system and method for using an image of a virtual reality interface (or part thereof) in real-time instant-message or video communication with a store employee of the physical shop that the virtual reality interface is replicating, with the purpose of using that image as part of the basis of exchange between the user, or customer, and the store employee to facilitate the purchase of an item (for example, an item contained in the image or a related item) from the physical store. Tagging of specific virtual reality images may be employed to aid the customer experience (for example, by automatically ‘linking’ the customer with an assistant in close physical proximity to the area in which the assistant took a snapshot of the virtual reality interface or part thereof). Tagging of specific virtual reality images (and parts of those images) may also be used as a reference point for a user's discussion with a sales assistant. For example, in addition to using a snapshot of a virtual interface, users may also use a specific reference of a virtual reality interface to form a part of the basis of discussion between the user and the store employee, where every accessible point in the virtual tour is effectively tagged with horizontal, vertical, and field-of-view (zoom level) coordinates such that a user's or customer's location in the virtual tour, direction of view, and level of zoom may form the basis of discussion between the user and the store employee.

“Virtual Reality” (VR) is defined as a system that uses either still panoramic photographs or video recorded panoramic shots in order to virtually replicate “real world” physical rooms or spaces. A “virtual reality interface” allows users to access this virtual reality and “move around” the interface using controls as provided. “Instant Messaging” (IM) is defined as a system that allows two or more users to engage in real-time text and/or photo transmission via the internet or mobile communication devices. “Video communication” is defined as a system that allows two or more users to communicate via simultaneous two-way video and audio transmissions from two or more locations via the interne or mobile communication devices.

The above-outlined invention of using an image or tagged reference of a virtual reality interface (or part thereof) in order to facilitate the virtual shopping experience via IM and/or video communication is a key feature of the creation of a virtual shopping hosting and interface platform which is expected to be called “Avenue Imperial” and would be run under the domain name avenueimperial.com (as well as related domain names). When registering with the website, the user can update a profile to include as required, for example, clothing and shoe sizes (for himself as well as anyone he may shop on behalf of).

Avenue Imperial will attempt to partner up with several physical ‘real-world’ retailers (attempting to start with well-known stores such as Harrods in the UK or Bergdorf Goodman in the US) and offer them the ability to replicate their physical store online (to be hosted on avenueimperial.com) via a high quality virtual reality interface that can be accessed from anywhere in the world via the internet or mobile devices. Eventually, the idea is to extend the service to cover discount villages (such as Bicester Village in the UK) and whole streets (such as Bond Street in London). This interface will then be used by customers around the world to allow them to ‘virtually browse’ the physical stores, to communicate with store employees and to purchase items directly from the physical stores.

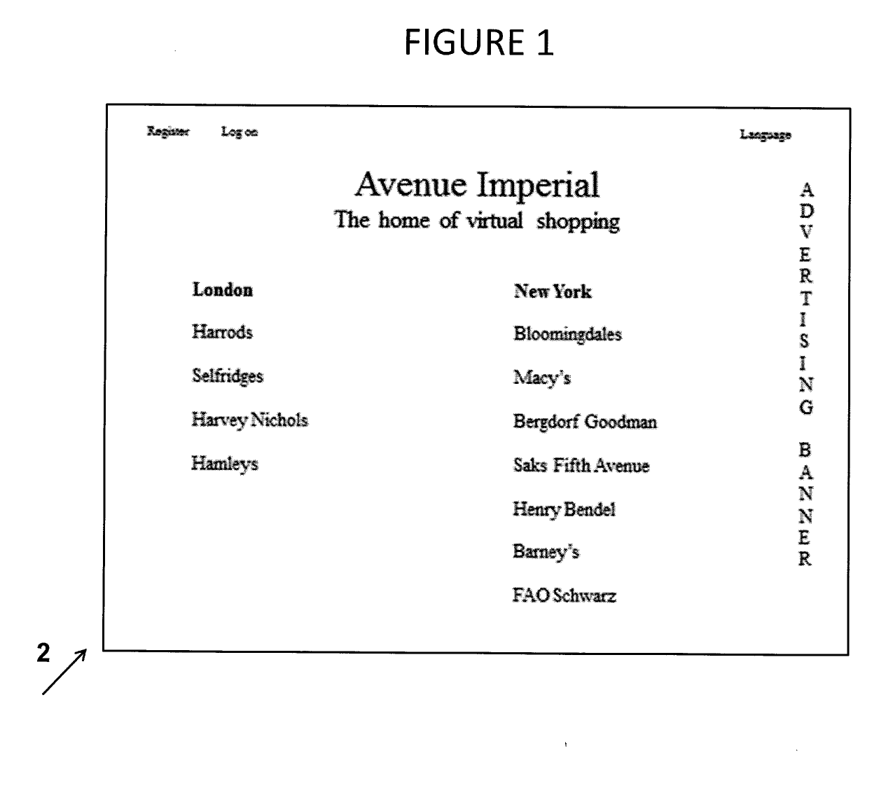

While a portion of most stores' product offering will be listed in their online store, many items in the physical stores are not available for purchase online via their online store. Allowing users to virtually access these physical stores online or via mobile devices will open up the possibility for shoppers around the world to access a desired physical store regardless of the user's current location. In other words, one would no longer have to be in London to shop at Harrods. FIG. 1 illustrates an example of how users will be given the option of shopping 2 at a selection of physical stores in different cities around the world.

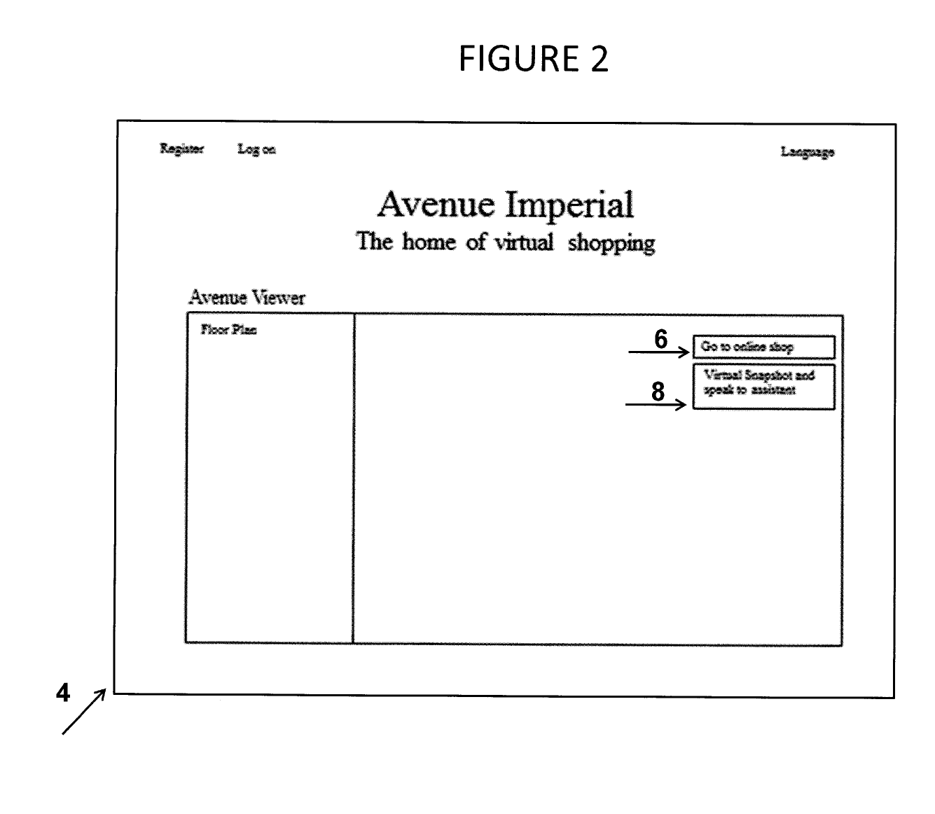

FIG. 2 illustrates a depiction of the virtual reality interface. As illustrated in FIG. 2, the virtual reality interface will allow users to browse 4 through the sections of the selected physical store that have been replicated online. If they have found a section of the store that they are interested in or a particular item that they are interested in purchasing, they will have the option to ‘go to online store’ or ‘go to online shop’ 6. This would open up a separate window in which they could access the archive of products from the store's online offering for the particular section of the store that they are currently viewing.

In addition to being able to access the store's online archive, users will have the ability to click on an option of ‘Virtual Snapshot and speak to assistant’ 8. This function and feature forms a crucial part of the virtual shopping and hosting platform. As before, users will be able to browse through the store until they have found an item that they are interested in purchasing. In addition to browsing, users may enter specific search terms (e.g. men's shoes) which will then be linked to that section of the replicated virtual version of the physical store. Once they have identified a desired item, they may click on ‘Virtual Snapshot and speak to assistant’ 8. This allows users to take a snapshot of the item that they are interested in. Alternatively, the user may upload a reference to the particular viewpoint that they are currently looking at.

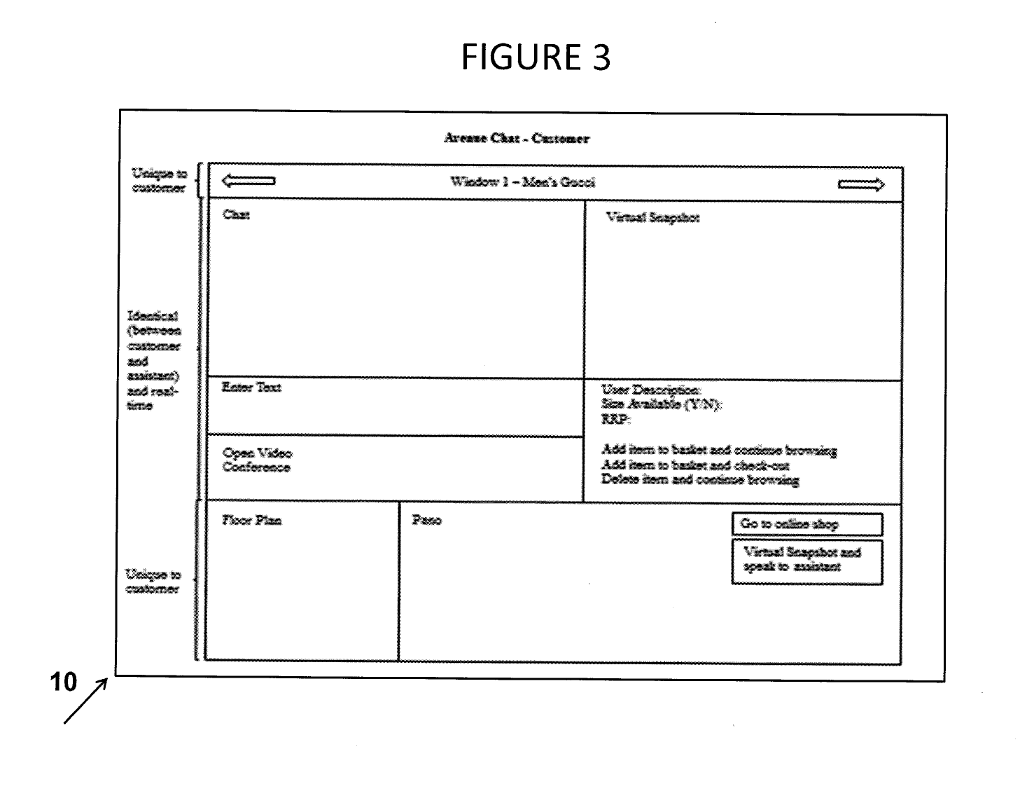

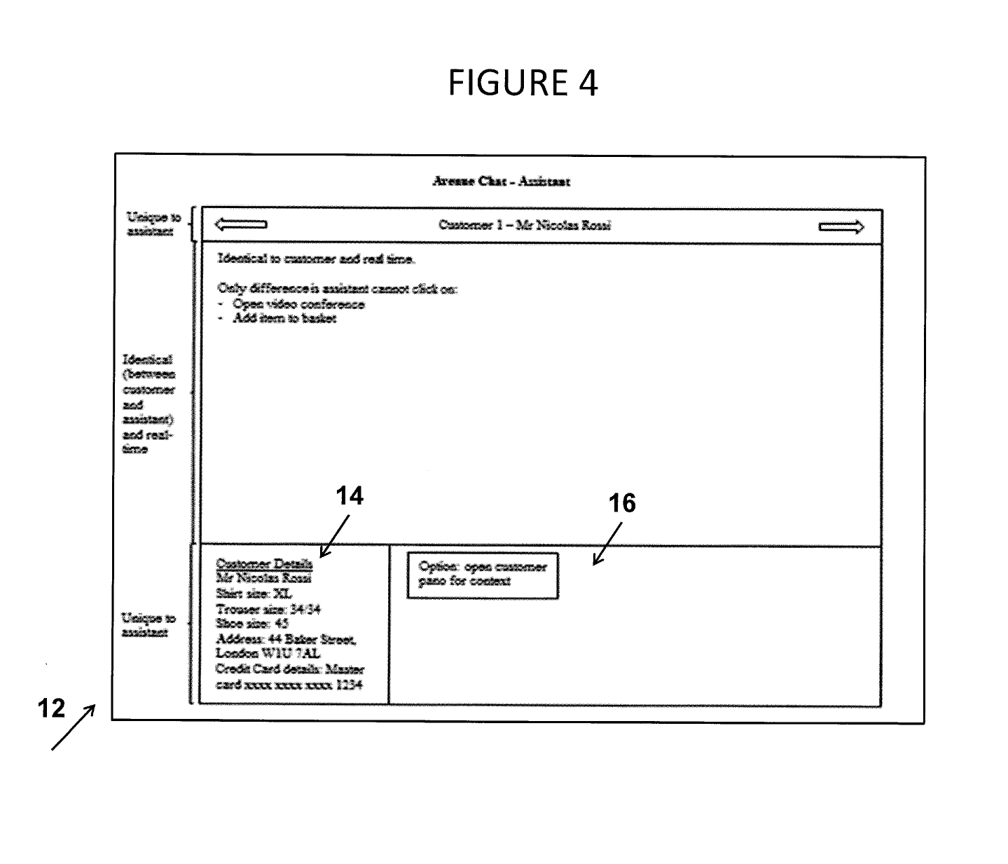

As illustrated in FIG. 3, this item will then automatically be uploaded and displayed on a ‘chat window’ system 10 (which includes the ability to instant message) via which users may communicate with a store assistant. This function will only be available when the real-world assistants are present in the physical store (for example, generally during the opening hours of the physical store). The user has to be registered to use this function which means, for example, his sizes (or the sizes of anyone he is intending to purchase for) will already be available for viewing on the IM system which will allow the assistant to check whether the desired item is available in those sizes, as illustrated in FIG. 4. The user will be asked to provide a description of the item next to the snapshot which will facilitate the interaction with the assistant and reduce the risk of potential misunderstandings. There will be a box next to the snapshot in which the assistant may enter the retail price for the desired item and whether the item is available in the desired size. The ability for the user to communicate with the store assistant via IM will be provided (allowing, for example, the user or the store assistant to ask and answer any questions they may have).

In addition to using IM, users will also be given the option of communicating via video. Both the user and the store assistant can use a web camera linked to one of their electronic devices. It may be particularly practical for the store assistant to use a tablet (or related-type) device as this would allow him to move around the store in order to facilitate the selection process and communication exchange with the user. This communication would run in addition to the IM communication.

Once the customer has submitted a request, a similar ‘chat window’ system 12 for the assistant, FIG. 4, would be opened on the assistant's device. As illustrated in FIG. 4, several parts of the assistant's ‘chat window’ 12 will be very similar to that of the customer's chat window 10. In addition, the assistant's chat window 12 will also have a section that shows the customer's details 14 (including, for example, clothing and shoe sizes) as well as the ability to ‘view customer pano’ 16.

Once the user has taken and confirmed a snapshot of a desired item and the ‘chat window’ 10 has been opened, reference coordinates to the customer's view (in which he took the snapshot) will be sent to the sales assistant. Sales assistants will then be given the option of opening up a link to those reference coordinates (therefore being able to view the exact same whole virtual reality image that the customer was viewing when taking the snapshot), as illustrated in FIG. 4. This allows the sales assistant to gain some ‘context’ (when needed). As an illustrative example, this might be particularly useful when a customer has chosen a black wallet on a stand with several similar black wallets so the sales assistant may not be certain as to which item exactly the customer wants. Allowing the assistant to pull up the customer viewpoint will help to give him the necessary context in those situations.

The ability to use the invention allows the virtual shopping experience to come much closer to resembling a ‘real-life’ shopping experience (as does the ability to virtually ‘browse’ around a physical store) and hence distinguishes itself significantly from the standard e-commerce process as the world knows it (which contains no virtual browsing or interaction with real-life assistants from those stores via IM and/or video communication). The invention greatly facilitates the virtual shopping experience by allowing users to communicate directly in real-time with assistants from the store (often in proximity to the particular section of the store where the user has identified a desired item) via IM and/or video communication, hence opening up a massive range of opportunities in linking real-life physical stores with consumers around the world via a virtual reality interface which may be accessed anywhere via the internet or via mobile devices.

The commercial aspect of the invention also distinguishes itself from existing virtual reality interfaces and hosting platforms. In addition to the fact that the invention allows for commercial transactions which use virtual reality images as part of the basis of the communication leading to the transaction, the invention also distinguishes itself from existing virtual reality interfaces and hosting platforms by allowing real-time instant-message or video communication with a store employee, with the snapshot or reference to a virtual reality image (or part thereof) forming part of the basis of this communication.

The ability for customers to browse through real-world physical stores via a VR interface and interact in real time with store employees distinguishes the invention from existing e-commerce platforms.

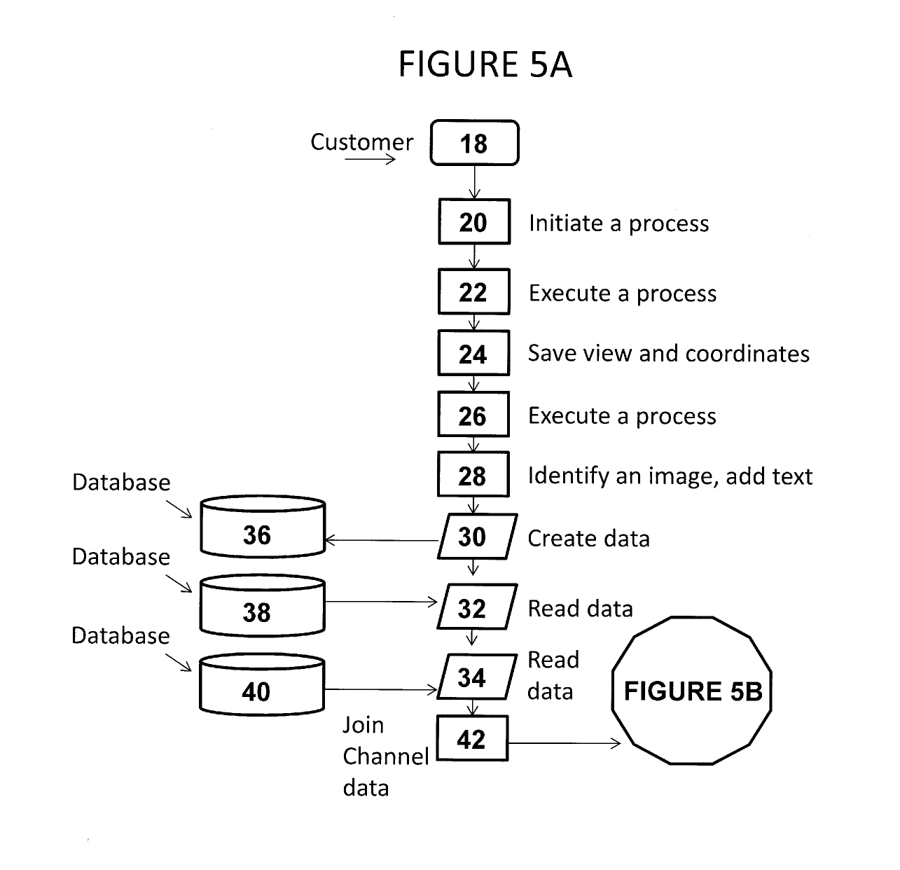

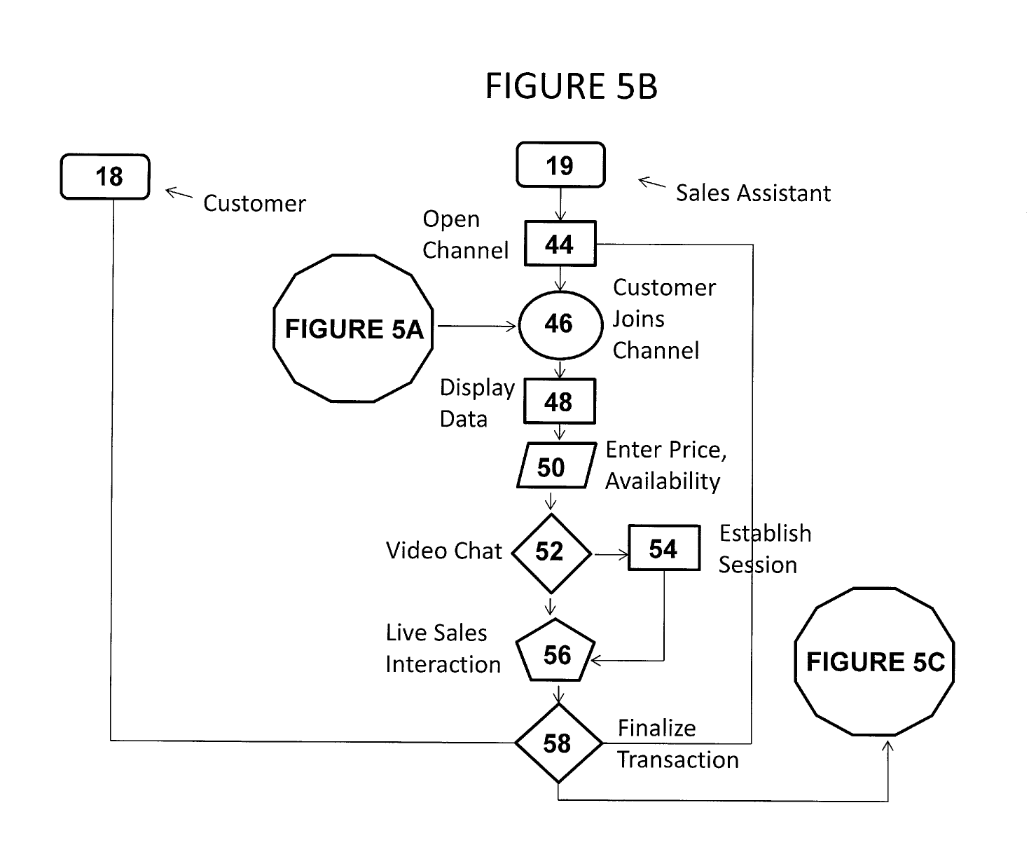

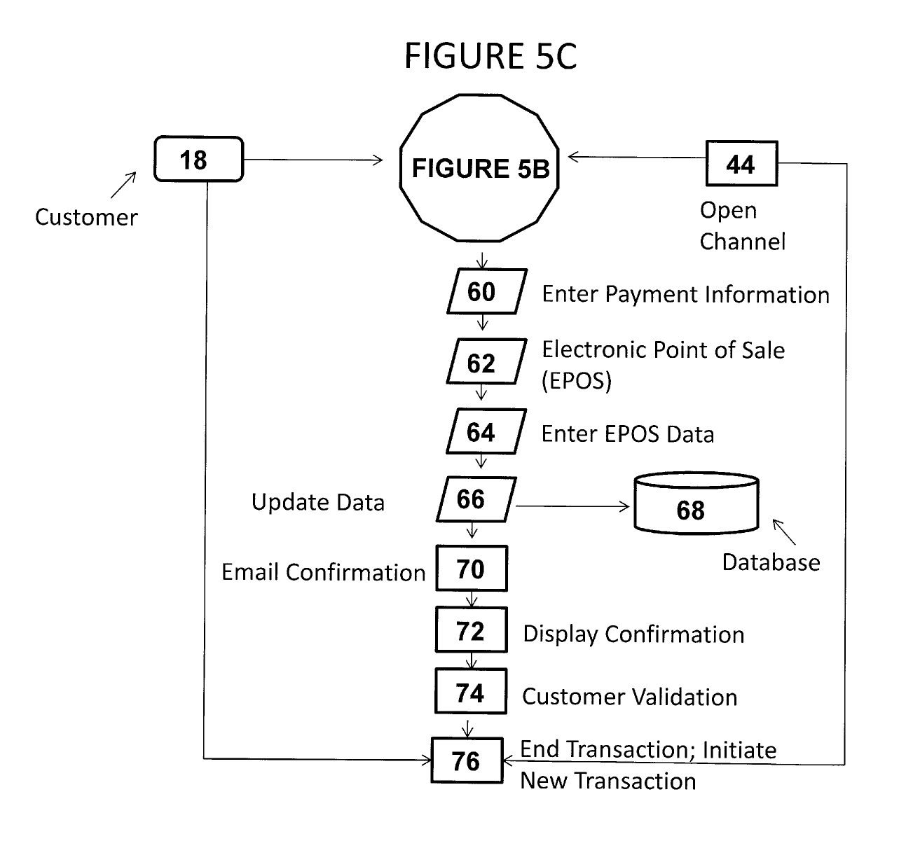

Referring now to the virtual snap flow diagram of FIG. 5A, FIG. 5B, and FIG. 5C, this flow diagram continues on from FIG. 5A to FIG. 5B to FIG. 5C and describes the process underpinning the invention by identifying the technical sub-processes and manual interventions committed by the two parties to the process; namely, these two parties being Customer 18 and Sales Assistant 19. The following assumptions are made: Customer 18 is assumed to be registered on the system at point of process; Customer 18 is identified by a unique identifier assigned at registration (customer_ID); Customer 18 has optionally updated their profile with sizing details for clothing and all credit card details except the three or four-digit CV2 security code; each panorama is identified by a unique identifier assigned during the post-production stage following a location shoot (pano_ID); Sales Assistant 19 is using a tablet (or related-device, as explained above) whose Unique Device ID (tablet_UDID) has been registered with Avenue Imperial with an entry in the database; each Unique Device ID (tablet_UDID) is associated in the database with a discrete set of panorama identifiers (pano_IDs) representing a specific in-store area such that, for example, tablet_UDID_{—}000001 may be recognized by the system as the device being used by the Sales Assistant 19 in, for example, “Harrods/Women's Footwear”; and each transaction is identified by a globally unique identifier assigned at point of transaction (trans_GUID).

With reference to FIG. 5A, Customer 18 selects “VirtualSnap and speak to assistant” 20 which initially runs the ShareView JavaScript 22 to retrieve co-ordinates representing the precise viewpoint and depth of zoom within a panorama, these are then stored as in-process variables along with the panorama identifier (pano_ID) 24. The VirtualSnap JavaScript 26 component is then executed bringing up a targeting tool 28 allowing the Customer 18 to take a snapshot of a target area of the screen containing the desired product and add a free text description. VirtualSnap 26 saves the snapshot image file to disk and creates 30 a database 36 record of database services 83 to include a unique transaction reference (trans_GUID), the description (text_desc) and a URL to the snapshot image file as saved on disk 38. The customer identifier (customer_ID) is retrieved from a database 38 of database services 83 The panorama identifier (pano_ID) is used to retrieve 34 from the database 40 of database services 83 the Unique Device ID (tablet_UDID) of the tablet in service at the physical in-store location and Customer joins 42 the appropriate PubNub channel as a Subscriber.

With reference to FIG. 5B, the Sales Assistant 19 maintains an open multiplexed PubNub channel as a Publisher with reference to the device's Unique Device ID (tablet_UDID) 44, this will support up to 100 concurrent connections to remote channel Subscribers (Customers). The Customer 18 has navigated to a specific panorama in the tour and has identified and zoomed in on a desired product or object(s) of interest. When Sales Assistant 19 accepts 46 a conversation with Customer 18 the transaction reference (trans_GUID) is used to retrieve and display 48 the snapshot image and description, the view co-ordinates are available to optionally display the panorama at precise viewpoint and depth of zoom, and the Customer identifier (customer_ID) is used to retrieve and display sizing details and credit card details 50. Optionally, Customer 18 may request 52 a video chat with Sales Assistant 19, where a peer-to-peer (signalling-serverless) WebRTC session communication protocol is instantiated 54 using the transaction reference (trans_GUID) as shared identifier. Sales Assistant 19 enters 56 pricing and availability information over the PubNub channel and participates as required in the further conversation over PubNub and optionally WebRTC. If no sale 56 is made, communications are exited and the transaction record and snapshot image file are deleted.

With reference to FIG. 5C, if a sale 58 is made, Customer 18 enters 60 the three or four-digit CV2 code as final security for the payment, Sales Assistant 19 processes payment 62 using in-store EPOS system 64 and adds a sales reference (sales _ID) 66. The system updates the database 68 record of database services 83 with the sales reference 66. The system automatically sends 70 an email to Customer confirming the transaction. After the sales confirmation is displayed 72 to the Customer 18, the Customer 18 acknowledges completion of the process by clicking ‘OK’ 74. Once communications are exited, Sales Assistant 19 returns to waiting 76 on the PubNub channel for another Customer request for assistance.

Some examples of processes that are automated (i.e. non-manual) include: the loading up of the virtual reality interface (FIG. 2) once the user has clicked on a desired store (FIG. 1); the ability for the user to ‘click himself’ to any section of the virtual reality interface using the floor plan (i.e. without having to manually navigate there); the loading up of a window (FIG. 3) which allows the customer to input a description and the store assistant to input the price and whether it's available in the desired size (FIG. 4); the automatic loading up of user information (including, for example, clothing and shoe sizes) for the assistant to view in order to check whether the desired item is available in that size (FIG. 4); the automatic presentation of the IM system and links to check-out and video conference as shown in FIGS. 3 and 4; the automatic sending of the reference coordinates of the user's virtual reality image/panorama to facilitate the sales process for the assistant; check-out without having to input credit card details again (i.e. registration is required to open up the ‘chat window’); and the automatic packaging and shipping (once the user has chosen a shipping method) post-checkout.

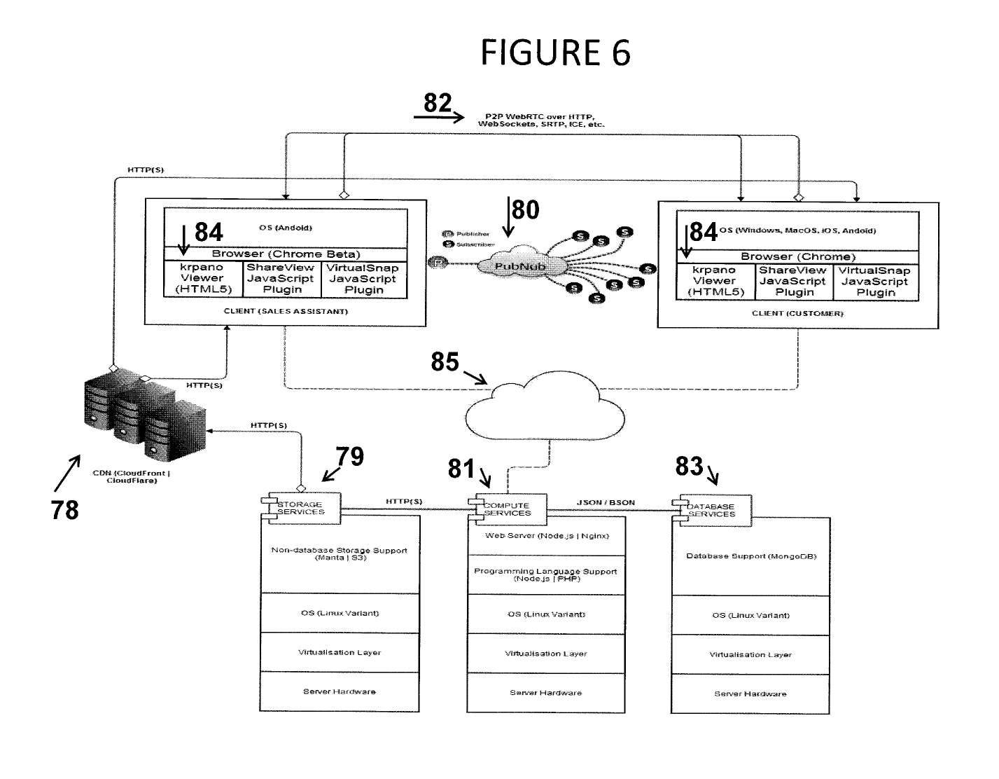

FIG. 6 is a block diagram of the virtual shopping system architecture. With reference to FIG. 6, the website is built using standard open source technologies including HTML5, CSS3 and JavaScript for the frontend with PHP or Node.js or other open source programming language for the backend hosted on Linux variant cloud servers. The virtual shopping system includes a plurality of data services, including storage services 79, compute services 81, and database services 83.

The storage services 79 describes the total system component used for storage of virtual tour assets (for example, panoramic image files) and their descriptor files (for example, XML files). The compute services 81 pulls these descriptor files from S3 over http or https and communicates directly with S3 over a RESTful API to derive panoramic image files as required. The non-database storage support (Manta|S3) represents the cloud-based file storage webs service provided by Amazon Web Services (AWS) known as S3 (Simple Storage Device). This is provided as a flat file storage system with no DBMS (database management system) support. The OS (Linux Variant) is the operating system variant that Amazon uses for its storage services; this is Amazon Linux, a proprietary Linux distribution based on Red Hat Enterprise Linux. The virtualization layer refers to the virtualization of Amazon's server hardware to allow multiple iterations and/or versions of operating system to be hosted across one or more physical servers. The server hardware represents the physical hardware layer as provided by Amazon through its AWS cloud.

The compute services 81 describes the total system component used for application logic, data processing, and web publishing. The compute services 81 communicates with database services 83 for database reads and writes using the JavaScript/Node.js programming languages with JSON (JavaScript Object Notation) as the data exchange format. The web server (Nodejs Nginx) is the web server software used. The programming language support (Node.js I PHP) is the server-side programming language used for massive user concurrency, a non-blocking event driven model supportive of integration with third party web services, and end-to-end JavaScript for the simplification of development and management. The OS (Linux Variant) is the operating system used. The virtualization layer refers to the virtualization of Pulsant's server hardware to allow multiple iterations and/or versions of operating system to be hosted across one or more physical servers. This is further cloudified and secured using a private cloud to further isolate the system from foreign systems. The server hardware represents the physical hardware layer as provided by the Pulsant Enterprise Cloud.

The database services 83 describes the total system component used for structure application data management, i.e. for all application data other than virtual tour assets and their descriptor files. The compute services 81 communicates with database services 83 for database reads and writes using the JavaScript/Node.js programming languages with JSON (JavaScript Object Notation) as the data exchange format. The data is stored in the MongoDB NoSQL database management system in the BSON (Binary JSON) format. The database support (MongoDB) is the NoSQL database management system used. The OS (Linux Variant) is the operating system used. The virtualization layer refers to the virtualization of Pulsant's server hardware to allow multiple iterations and/or versions of operating system to be hosted across one or more physical servers. This is further cloudified and secured using a private cloud to further isolate the system from foreign systems. The server hardware represents the physical hardware layer as provided by the Pulsant Enterprise Cloud.

Persistent metadata such as tags or indexes linking scenes (panoramas) with sales assistants (specific in-store tablet devices) are committed to a SQL or NoSQL database, such as MongoDB. Images such as those created for the 360 degree panoramas as well as other static content such as HTML, CSS and JavaScript will be served from an EU-based origin over servers in a global Content Delivery Network 78 to ensure optimal performance and platform scalability. With reference to systems to access website and user interface, the present invention is implemented using software which may be written in many programming languages or implemented with many web-generation tools. The present invention may be used on a global or local computer network, on a personal computer, on viewable storage media such as a CD ROM, on a wireless telephone, on a ‘tablet’ device such as the iPad, or on any type of wired or wireless device that allows users to access the virtual reality interface.

The system of 360 degree panorama capture will be carried out by 360 video camera or DLSR camera and a fisheye lens. The process of stitching these panoramas will be made by readily available panorama stitching software. The virtual interface has been designed using ready available technologies such as flash, html5 and javascript but the virtual interface is entirely bespoke to our needs to be able to place hotspots between panoramas and identify panorama locations using a wifi gps system.

The photographer may upload panoramas to the virtual interface and then access then tour editing page. Hotspots are accessed by clicking a button to add a graphic hotspot icon, and be shown a menu to assign a unique panorama to this hotspot, which will automatically create xml code into the tour.

The snapshot plugin is part of the user interface to the virtual tour and upon publishing the users will be able to take a small screen image of any view within the 360 panorama as they navigate and use this image as the basis of their shopping inquiry. The snapshot plugin is written in Flash for desktop, and html5 and javascript for tablet and mobile, and uses PHP to save and store images on a PHP 5 enabled server. The ‘snapshot’ image appears in the appropriate placeholder on the inquiry form, and is seen by the service assistant when the user clicks to send the inquiry. The inquiry form refers to the screen displayed for the customer once they have submitted a SnapShot request and are queued for service by an in-store sales assistant 19. The screen consists of one or more SnapShot images and the customer's 18 product description(s), a message indicating the target response time for the store 102 (configurable per store), and the customer's 18 position in the service queue. This inquiry form will be dynamically updated with product price, product availability and the product's official brand title once the sales assistant has responded to the initial service request and supplied this information.

Real-time messaging functionality is delivered to the application over the PubNub Real-Time Network 80 (Unicast method for one-to-one private communication); this 3rd party web service supports millions of concurrent global connections between heterogeneous devices offering <50 ms response times globally. The Socket.io network library may be deployed in support of connection multiplexing to allow, for example, one sales assistant to manage up to one hundred concurrent chat sessions making for an effective ‘flat’ message queuing system. For example, a communication protocol 82 such as WebRTC, as an emerging real-time communications standard for video supported by W3C (Worldwide Web Consortium), IETF (Internet Engineering Task Force) and Google amongst others, may be used to support peer-to-peer in-browser video chat without plugins. This may be built on the 3rd party OpenTok platform or natively using the Open Peer SDK from Hookflash. Browser support 84 for WebRTC is currently available in Chrome, IE+Chrome Frame Plugin and Firefox Nightly test build (desktop) and Chrome Beta for Android (mobile/tablet) so initially the platform will support these browsers/devices once they are connected through the Internet 85. Initially, the Avenue Imperial platform will simply support encrypted transfer of payment details (for example, such as credit cards) from customer to sales assistant, optionally allowing regular customers to save credit card details on Al's PCI-compliant servers.

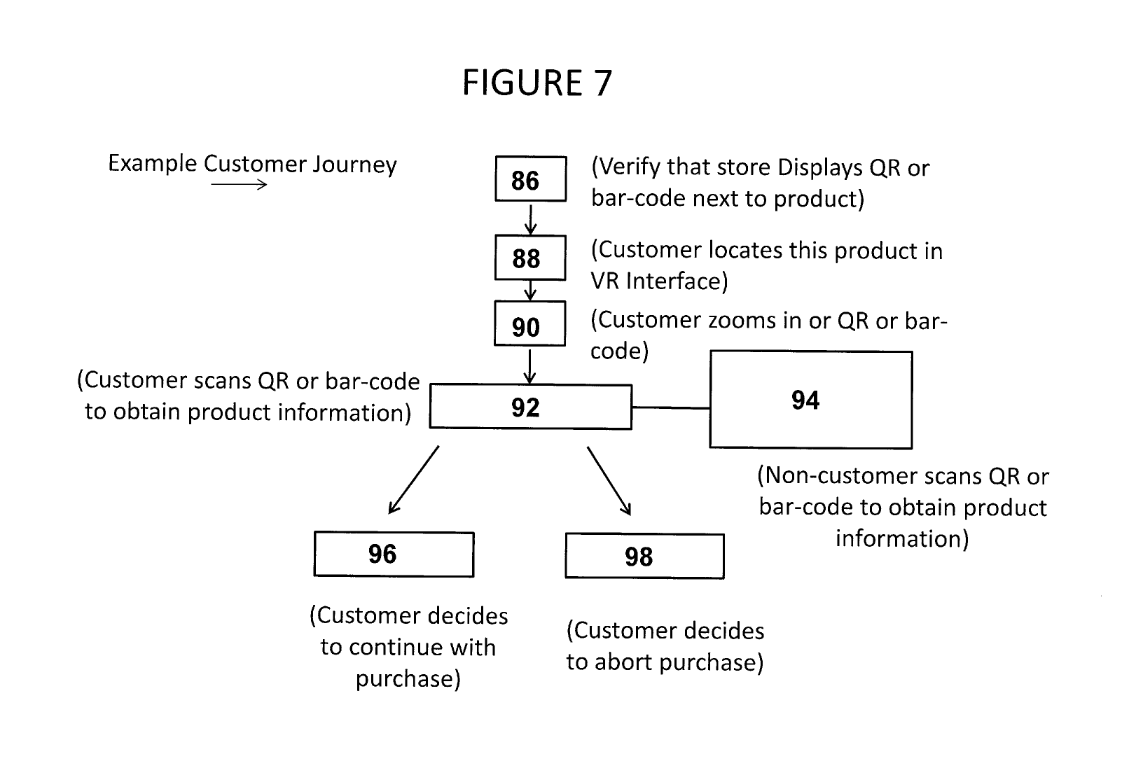

FIG. 7 is a flow chart illustrating the steps of the product code interaction with the virtual reality interface. Additionally, a method for using Quick Response (QR) codes or product bar codes (both the ‘QR’ and ‘bar codes’ may be referred to as ‘product codes’) allows users in the virtual reality interface to gather more information about certain products displayed in the virtual reality interface with the purpose of assisting the user in his information discovery process and route to purchasing a product from the virtual reality interface. The product codes must be placed 86 in a clearly visible way on or next to the products prior to the filming/shooting of the tour. When accessing 88 the virtual reality interface, users may then zoom in on the product codes 90 and use their mobile devices 92 (or other product code reading devices) to pull up product information that the retailer has chosen to include in the product code link. Alternatively, the virtual reality interface may have a 3^{rd} party ‘code scanning’ application which may be used to scan QR or bar codes directly from the system so that, for example, the customer does not have to use his or her mobile device. At this point, the customer may decide to move forward with the purchase process 96, where he or she takes a snapshot of the product which links him or her to an in-store assistant. Otherwise, the customer may decide to abort the purchase process 98 because, for example, he or she thinks that the product is too expensive relative to what he or she is willing to pay.

As explained earlier, and in connection with and incorporating the virtual reality interface described above, the use of an image of a virtual reality interface in real-time instant-message communication with a store employee of the physical shop that the virtual reality interface is replicating may run into issues relating to the amount of time that the store assistant will have to dedicate to serving the online customer using this function. In particular, the invention requires an assistant to inform the customer of the product description, price and availability of a desired product following the customer snapshot request.

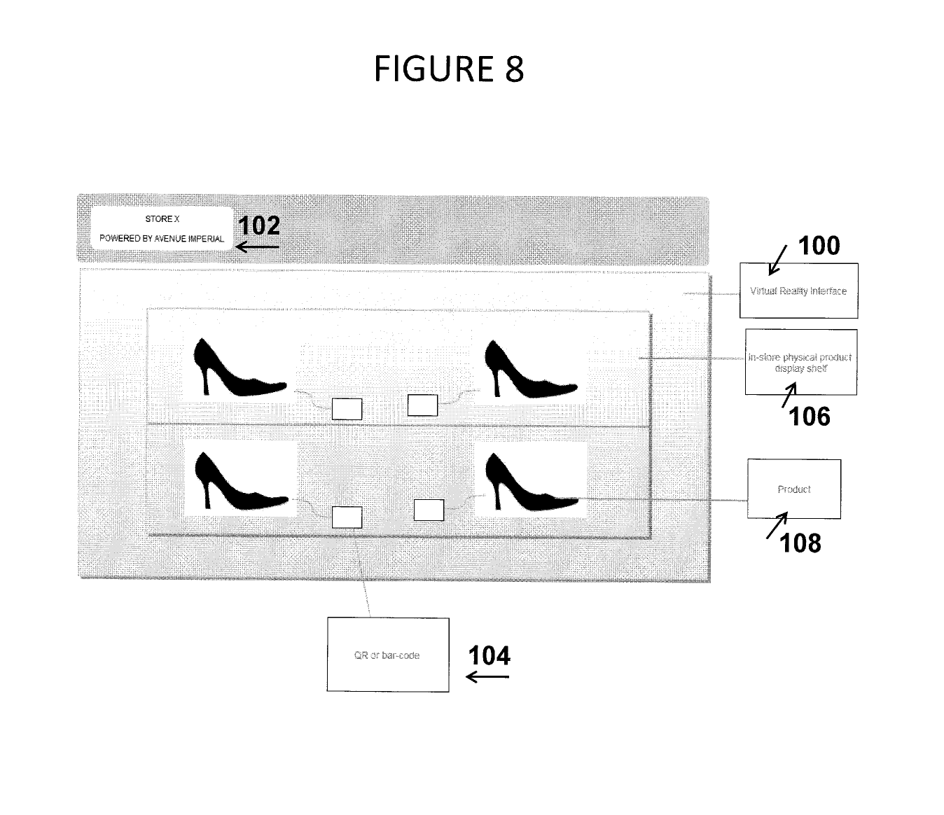

FIG. 8 is a schematic diagram illustrating product codes of the virtual reality interface. As illustrated in FIG. 8, a method that uses well-displayed QR or bar codes that have been placed on or next to the products 108 in the virtual reality interface 100 by the store 102 may simplify and speed up the interaction between the online customer and the sales assistant significantly by providing the customer the ability to zoom into the product code 104 and provide any information that the store 102 wishes to include (for example, such as a product description, price of the product, sizes in which the product 108 is available, additional photos, etc.) in the product code link. Such a method would be beneficial to the store 102 as it uses up significantly less assistant time. The use of an image from the virtual reality interface (i.e. a snapshot) may still be employed even when well-displayed product codes 104 have been placed in the virtual reality interface 100. For example, a customer may see a product 108 he likes in the virtual reality interface 100, he zooms into the product 108 from the in-store 102 physical product display shelf 106 and pulls up the QR-code link on his mobile device (or other QR-code reading device) and views the information provided, he decides to buy the product 108 so he takes a snapshot of the product which gets sent to the in-store assistant who then uses this snapshot as the basis for any further communication with the customer in order to facilitate the sales process, as illustrated in FIG. 7.

As further illustrated in FIG. 8, the placing of product codes 104 in a virtual reality interface would be beneficial to the customer as it provides a faster and completely automated way for the customer to access product information for a product 108 displayed in the virtual reality interface 100. With the virtual reality interface 100, there may be a lag between when a customer makes a snapshot request until he has received the information desired. This time lag may be particularly long during times when the physical store is busy with physical customers (such as on weekends, during ‘sales’ periods), hence acting as a deterrent to users of the virtual reality interface 100 to purchase products 108 as well as a deterrent to stores who wish to incorporate the virtual reality interface 100 as part of their offering. While the use of product codes 104 may require a more time-intensive set-up for the stores 102 (by having to build QR-code links and then place them on the products in a clearly visible way), the increased speed and automation of the actual customer-assistant interaction may result in an increase in activity on the system. To speed up the process even further, the virtual reality system may incorporate a function (which would be available directly on the virtual reality interface 100) that pulls up a QR or bar-code reader. This means the user will not even have to use his mobile device (or other QR or bar-code reading device) to pull up more product 108 information.

Although the present invention has been shown and described with respect to several preferred embodiments thereof, various changes, omissions and additions to the form and detail thereof, may be made therein, without departing from the spirit and scope of the invention.

What is claimed is:

1. A virtual shopping system comprising:
a plurality of data services;
a content delivery network that receives at least one request from at least one of said data services;
at least two devices operating in a communication protocol that receive data from said content delivery network, said at least two devices each include a virtual reality interface, said virtual reality interface:
creates a user a virtual replica of a physical store;
locates one or more objects of interest from said virtual reality interface; and
interacts with said at least two devices located in said physical store through a virtual snapshot by said virtual reality interface of a user's current view of said virtual replica to facilitate purchase of one or more objects of interest.

2. The system of claim 1, wherein said content delivery network comprises a plurality of servers.

3. The system of claim 1, wherein said communication protocol comprises WebRTC communication.

4. The system of claim 1, wherein said plurality of data services comprises storage services, compute services, and database services.

5. The system of claim 1, wherein said virtual reality interface interacts with said at least two devices through real-time instant messaging or video communication.

6. The system of claim 1 further comprising a unique identifier that is assigned to said user during user registration of said system.

7. The system of claim 1, wherein said virtual snapshot is saved as an image file to a disk of said data services.

8. The system of claim 1, wherein said virtual reality interface comprises a product code link that is associated with a description, price, and size of said one or more objects of interest.

9. The system of claim 1, wherein said virtual replica comprises still panoramic photographs or video recorded panoramic shots by a camera to virtually replicate physical rooms or spaces of said physical store.

10. The system of claim 9 further comprising a module that retrieves coordinates of viewpoint and depth of zoom within a panoramic photograph.

11. The system of claim 1, wherein at least one of said devices is registered with an entry in a database of said data services.

12. The system of claim 11, wherein said at least one of said devices is associated with a discrete set of panorama identifiers that represents a specific area of said physical store.

13. A method of virtual shopping comprising:
providing a plurality of data services;
providing a content delivery network that receives at least one request from at least one of said data services;
providing at least two devices operating in a communication protocol that receive data from said content delivery network, said at least two devices each include a virtual reality interface, said virtual reality interface:
creates a user a virtual replica of a physical store;
locates one or more objects of interest from said virtual reality interface; and
interacts with said at least two devices located in said physical store through a virtual snapshot by said virtual reality interface of a user's current view of said virtual replica to facilitate purchase of one or more objects of interest.

14. The method of claim 13, wherein said content delivery network comprises a plurality of servers.

15. The method of claim 13, wherein said communication protocol comprises WebRTC communication.

16. The method of claim 13, wherein said plurality of data services comprises storage services, compute services, and database services.

17. The method of claim 13, wherein said virtual reality interface interacts with said at least two devices through real-time instant messaging or video communication.

18. The method of claim 13 further comprising the step of assigning a unique identifier to said user during user registration of said system.

19. The method of claim 13, wherein said virtual snapshot is saved as an image file to a disk of said data services.

20. The method of claim 13, wherein said virtual reality interface comprises a product code link that is associated with a description, price, and size of said one or more objects of interest.

21. The method of claim 13, wherein said virtual replica comprises still panoramic photographs or video recorded panoramic shots by a camera to virtually replicate physical rooms or spaces of said physical store.

22. The method of claim 21 further comprising the step of retrieving coordinates of viewpoint and depth of zoom within a panoramic photograph.

23. The method of claim 13, wherein at least one of said devices is registered with an entry in a database of said data services.

24. The method of claim 23, wherein said at least one of said devices and is associated with a discrete set of panorama identifiers that represents a specific area of said physical store.
